(19) United States
(12) Patent Application Publication
(10) Pub. No.: US 2018/0340138 A1
(43) Pub. Date: Nov. 29, 2018

(54) ENZYME STABILIZERS

(71) Applicant: Henkel AG & Co. KGaA, Duesseldorf (DE)

(72) Inventors: Andre Haetzelt, Duesseldorf (DE); Timothy O'Connell, Landsberg am Lech (DE)

(73) Assignee: Henkel AG & Co. KGaA, Duesseldorf (DE)

(21) Appl. No.: 15/778,904

(22) PCT Filed: Nov. 15, 2016
(86) PCT No.: PCT/EP2016/077625

§ 371 Date: May 24, 2018

(30) Foreign Application Priority Data
Nov. 25, 2015 (DE) 10 2015 223 268.9

(51) Int. Cl. C11D 3/386; C11D 3/34

(52) U.S. Cl. CPC C11D 3/38663; C11D 11/0017; C11D 3/349

(57) ABSTRACT

The present disclosure relates to washing and cleaning agents comprising at least one protease and at least one organic compound of the formula (I) which acts as protease inhibitor, and is thus a suitable enzyme stabilizer, as well as the use of these compounds as enzyme stabilizers in washing and cleaning agents comprising protease. The corresponding washing and cleaning methods and the use of the agents describe here are also a component of the present disclosure.

### CROSS-REFERENCE TO RELATED APPLICATION

This application is a U.S. National-Stage entry under 35 U.S.C. § 371 based on International Application No. PCT/EP2016/077625, filed Nov. 15, 2016 which was published under PCT Article 21(2) and which claims priority to German Application No. 10 2015 223 268.9, filed Nov. 25, 2015, which are all hereby incorporated in their entirety by reference.

### TECHNICAL FIELD

The present disclosure relates to washing and cleaning agents containing at least one enzyme and at least one organic compound which acts as protease inhibitor, and is thus a suitable enzyme stabilizer, as well as the use of these compounds as enzyme stabilizers in washing and cleaning agents containing enzymes.

### BACKGROUND

The use of enzymes in washing and cleaning agents has been established in the prior art for decades. They are used to expand the performance spectrum of the relevant agents according to their special activities. This includes, in particular, hydrolytic enzymes such as proteases, amylases, lipases and cellulases. The first three of the aforementioned enzymes hydrolyze proteins, starches and fats and thus make an immediate contribution to dirt removal. Cellulases are used for their tissue effect, in particular. Another group of washing and cleaning agent enzymes comprises enzymes, particularly oxidases, which are used advantageously in combination with other components to bleach soiling or to generate the bleaching agents in situ. In addition to these enzymes, which are undergoing continuous optimization, other enzymes are in constant development for use in washing and cleaning agents in order to optimally attack special types of soiling, such as pectinases, β-glucanases, mannanases or other hemicellulases (glycosidases) for hydrolysis of special plant-based polymers, in particular.

The longest-established enzymes contain in practically all modern high-performance washing and cleaning agents are proteases, including, in particular serin-proteases, which also comprise the subtilases as contemplated herein. They are used to decompose soiling containing protein on the material to be cleaned. However, they also hydrolyze on themselves (autoproteolysis) and all other proteins contained in the respective agents, particularly enzymes. This takes place especially during the cleaning process, i.e. in the hydrous washing liquor, when comparatively favorable reaction conditions are present. This also takes place to a lesser extent during the storage of the agents in question, for which reason extended storage times also entail a certain loss of protease activity and the activities of the other enzymes. This is especially problematic in gel-like or liquid and hydrous recipes, in particular, because they provide the reaction medium and hydrolysis reagent with the water.

An objective in the development of washing and cleaning agent recipes is to stabilize the enzymes contained therein during storage. This is understood to include protection from various unfavorable influences, such as denaturing or decomposition due to physical influences or oxidation. An emphasis of these developments it the protection of the proteins contained and/or enzymes contained therein from proteolytic cleavage. This can take place due to the build-up of physical barriers, such as encapsulation of the enzymes in special enzyme granules or due to the packaging of the agents in two- or multi-chamber systems. The other repeatedly applied approach is to add chemical compounds which inhibit the proteases and thereby act as stabilizers for proteases and the other contained proteins and enzymes. Said compounds must be reversible protease inhibitors, because the protease activity should only be temporarily suppressed during storage, but not during the cleaning process.

Reversible protease inhibitors known according to the prior art are polyols, particularly glycerin and 1,2-propylene glycol, benzamidine-hydrochloride, borax, boric acid, boronic acid or salts or esters established thereof. This includes, in particular, derivatives with aromatic groups, such as ortho-, meta- or parasubstituted phenylboronic acids, particularly 4-formylphenyl boronic acid, or the salts or esters of said compounds. Especially good protection is achieved when the boronic acid derivatives are used together with polyols, because they can then form a complex that stabilizes the enzyme. Peptide aldehydes, i.e. oligopeptides with reduced C-terminus, particularly those of from about 2 to about 50 monomers, are described for this purpose. Peptidic reversible protease inhibitors include ovomucoid and leupeptin. Specific, reversible peptide inhibitors and fusion proteins of proteases and specific peptide inhibitors are used for this purpose.

Additional established enzyme stabilizers are amino alcohols, such as mono-, di-, triethanol- and -propanolamine and mixtures thereof, aliphatic carboxylic acids up to C₁₂, such as succinic acid, other dicarboxylic acids or salts of said acids. Terminal group capped fatty acid amide oxylates are also established for this purpose. Certain organic acids can be used as builders, as disclosed in WO 97/18287, to stabilize an enzyme in addition to their builder function.

Various protease classes have been established as washing and cleaning agent proteases, such as metalloproteases. Among washing and cleaning agent proteases, proteases of the subtilisin type (subtilases, subtilopeptidases, EC 3.4.21.62) have been found to be outstanding due to their advantageous enzymatic properties, such as stability or pH optimum. They are attributed to serin proteases due to the catalytic amino acids. They act as non-specific endopeptidases, which means they hydrolyze arbitrary acid amide bonds that are in the interior of peptides or proteins. Their pH optimum is usually in clearly in the alkaline range. An overview of this family is provided, for example, by the article “Subtilases: Subtilisin-like Proteases” by R. Siezen, page 75-95 in “Subtilisin enzymes”, published by R. Bott and C. Betzel, New York, 1996. Subtilases are formed naturally by microorganisms this includes, in particularly, the subtilisins formed and secreted by bacillus species as the most important group within subtilases.

Therefore, work is taking place specifically on providing reversible inhibitors of this specific enzyme class. In the process, polyols, such as glycerin and 1,2-propylene glycol, have not been found to be advantageous because of their high necessary usage concentrations, because the remaining active ingredients of the relevant agents can only be contained in correspondingly low portions.

Among the already active serin-protease inhibitors in comparatively lower concentration, boric acid derivatives have been found to be outstanding. However, independently of their stabilizing effect, the boric acid derivatives have a crucial disadvantage: many of these, such as borat, form undesired bi-products with other washing and/or cleaning agent ingredients, so that they are no longer available in the relevant agents for the desired cleaning purpose or are even left behind as an impurity on the item to be washed.

### BRIEF SUMMARY

A washing or cleaning agent is provided herein. The washing or cleaning agent includes, but is not limited to, at least one protease and at least one enzyme stabilizer. The at least one enzyme stabilizer is selected from the group of compounds of the general structural formula (I)

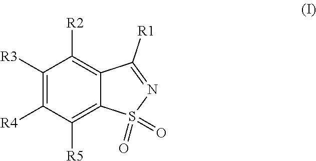

wherein R1 denotes a C₁-C₆ alkyl group, a C₂-C₆ alkenyl group, a C₂-C₆ hydroxy alkyl group, a C₁-C₆ alkyl-oxy-C₁-C₆ alkyl group, a carboxy-C₁-C₆ alkyl group, an aryl-C₁-C₆ alkyl group, a heteroaryl-C₁-C₆ alkyl group, an aryl group, or a heteroaryl group, and R2, R3, R4, and R5, each independently of each other, denote hydrogen, a C₁-C₆ alkyl group, a halogen atom, or a C₁-C₆ acyl group.

Another washing or cleaning agent is provided herein. The washing or cleaning agent includes, but is not limited to, at least one protease including a subtilisin protease. The washing or cleaning agent further includes, but is not limited to, at least one enzyme stabilizer including 3-methyl-benzisothiazol-1,1-dioxide. The at least one protease is included in an amount of from about 0.05 to about 2 wt. % relative to the total weight of the washing or cleaning agent. The at least one enzyme stabilizer is included in an amount of from about 0.05 to about 5 wt. % relative to the total weight of the washing or cleaning agent.

### DETAILED DESCRIPTION

The following detailed description is merely exemplary in nature and is not intended to limit the disclosure or the application and uses of the subject matter as described herein. Furthermore, there is no intention to be bound by any theory presented in the preceding background or the following detailed description.

The present disclosure addresses the problem of identifying boron-free compounds which act as protease inhibitors and are suitable for use as enzyme stabilizers in washing and cleaning agents. In this connection, use in liquid, gel-like or pasty washing and cleaning agents is of particular interest, including such agents which contain water.

This problem is solved with washing or cleaning agents which contain at least one protease and at least one enzyme stabilizer, wherein the at least one enzyme stabilizer is selected from compounds of the general structural formula (I)

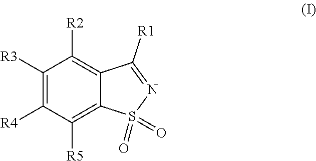

wherein R1 denotes a C₁-C₆ alkyl group, a C₂-C₆ alkenyl group, a C₂-C₆ hydroxy alkyl group, a C₁-C₆ alkyl-oxy-C₁-C₆ alkyl group, a carboxy-C₁-C₆ alkyl group, an aryl-C₁-C₆ alkyl group, a heteroaryl-C₁-C₆ alkyl group, an aryl group or a heteroaryl group, and R2, R3, R4 and R5, each independently of each other, denote hydrogen, a C₁-C₆ alkyl group, a halogen atom or a C₁-C₆ acyl group.

Examples as substituents of the compounds of formula (I) include, but are not limited to the following: Examples of C₁-C₆ alkyl radicals are the groups —CH₃, —CH₂CH₃, —CH₂CH₂CH₃, —CH(CH₃)₂, —CH₂CH₂CH₂CH₃, —CH₂CH(CH₃)₂, —CH(CH₃)CH₂CH₃, —C(CH₃)₃.

Examples of a C₂-C₆ alkenyl group are a prop-2-enyl group (allyl group), a 2-methyl-prop-2-enyl group, a but-3-enyl group, a but-2-enyl group, a pent-4-enyl group or a pent-3-enyl group, where prop-2-enyl group is preferred. Examples of a C₂-C₆ hydroxyalkyl group are —CH₂CH₂OH, —CH₂CH₂CH₂OH, —CH₂CH(OH)CH₃ and —CH₂CH₂CH₂CH₂OH, where the group CH₂CH₂OH is preferred. Examples of C₁-C₆-alkyl-oxy-C₁-C₆-alkyl groups are the groups —CH₂CH₂OCH₃, —CH₂CH₂CH₂OCH₃, —CH₂CH₂OCH₂CH₃, —CH₂CH₂CH₂OCH₂CH₃, —CH₂CH₂OCH(CH₃)₂, —CH₂CH₂CH₂OCH(CH₃)₂. Examples of a carboxy-C₁-C₆ alkyl group are the carboxy methyl group, the 2-carboxy methyl group or the 3-carboxy propyl group. Examples of aryl-C₁-C₆ alkyl groups are the benzyl group and the 2-phenyl ethyl group. Examples of a heteroaryl-C₁-C₆ alkyl group are the pyridin-2-ylmethyl group, the pyridin-3-ylmethyl group, the pyridin-4-ylmethyl group, the pyridin-2-ylmethyl group, the pyrrol-1-ylmethyl group, the pyrrol-1-ylethyl group, the pyrazol-1-ylmethyl group or the pyrazol-1-ylethyl group. Examples of an aryl group are the phenyl group, the 1-naphthyl group or the 2-napthyl group. Examples of a heteroaryl group are the pyridin-2-yl group, the pyridin-3-yl group, the pyridin-4-yl group, the pyrimidin-2-yl group, the pyrrol-1-yl group, the pyrrol-2-yl group, the pyrazol-1-yl group, the pyrazol-3-yl group or the pyrazol-4-yl group. Examples of a C₁-C₆ acyl group are acetyl (1-oxo-ethyl), 1-oxo-propyl, 1-oxo-butyl, 1-oxo-pentyl, 1-oxo-2,2-dimethylpropyl and 1-oxo-hexyl.

In an embodiment of the present disclosure, the compounds according to formula (I) including the radical R1 for the general structure (I) denotes a C₁-C₆ alkyl group, a C₂-C₆ alkenyl group or a C₂-C₆ hydroxyalkyl group. As contemplated herein, in certain embodiments, the radical R1 denotes a C₁-C₆ alkyl group, preferably methyl, ethyl, n-propyl, isopropyl, n-butyl, 2-butyl or tert-butyl and particular preference is given to methyl.

In different embodiments of the present disclosure, R2, R3, R4 and R5 stand for hydrogen in each case in the compounds according to formula (I).

Another embodiment of the present disclosure, therefore, is exemplified in that the compound according to formula (I) is a 3-alkyl-1,2-benzoisothiazol-1,1-dioxide.

Particularly suitable compounds, therefore, are selected from 3-methyl-, 3-ethyl-, 3-(1-propyl)-, 3-isopropyl-, 3-(1-butyl)-, 3-(2-butyl)-, and 3-(tert-butyl)-1,2-benzisothiazol-1,1-dioxide, particularly 3-methyl-1,2-benzisothiazol-1,1-dioxide.

The term washing or cleaning agent, as contemplated herein, is understood to mean all agents that are suitable for washing or cleaning of textiles and/or solid surfaces, in particular. Further suitable ingredients are described in detail further below.

The term protease as contemplated herein is understood to mean all enzymes that are capable of hydrolyzing acid amide linkages of proteins. The proteases are also described in detail further below.

Without a desire to be bound to a theory, it is assumed, as contemplated herein, that the relevant compounds for the present disclosure form a complex with the protease to be inhibited/stabilized as contemplated herein. This is probably manifested such that the relevant compound for the present disclosure is incorporated in the substrate binding bag of the protease and is non-covalently bound there. In this manner, the active center of the protease is blocked by the compound which is not hydrolyzable with this enzyme and is available for a hydrolysis of other added proteins. In this connection, it is a reversible bond, which means there is an equilibrium between association and dissociation. The equilibrium coefficient of this reaction is identified as an inhibition constant or K.

The first advantage of the relevant compounds for the present disclosure in comparison with the prior art is that they have advantageous inhibition constants with respect to the proteases which can be used in the washing and cleaning agents. Therefore, the inhibitors bond reversibly, which means they do not coalesce into solid and not to lose temporary interactions with the enzyme. Therefore, the majority of the relevant proteases for the present disclosure is present in the form of a protease-inhibitor complex during storage. The proteases and, optionally, additionally contained proteins, particularly additional enzymes, are protected from a proteolysis by this enzyme in this manner (stabilized against proteolysis) and are thus have no performance limitations even after storage. On the other hand, at the moment of dilution of the agent as contemplated herein with water to produce a hydrous washing and/or cleaning bath, the bonding equilibrium shifts towards dissociation so that the complex dissolves and the majority of the relevant proteases for the present disclosure can become proteolytically active.

The second advantage of the relevant compounds for the present disclosure in comparison with the state of the art is that they only have C, H, N, S and O as elements and are free from boron, in particular. Consequently, they do not form the undesired bi-products that are traced back to boron with other washing or cleaning agent ingredients.

Moreover, they have very good water solubility, in particular, due to the contained carboxyl or sulfonyl groups, so that they can be incorporated into corresponding agents easily and a loss during storage is avoided.

Basically, the aforementioned compounds probably act as reversible inhibitors, because they are adapted structurally to the conditions of the binding bag in a similar manner to the substrate of the proteases. This applies, in particular, for serin proteases, such as those which have been demonstrated on the basis of the examples for the present application with the positive effect of the experimental compounds described there on the basis of serin proteases, specifically subtilases, even more specifically, subtilisins.

Additional subject matter of the present disclosure relates to:
the use of a compound described above as a reversible inhibitor and/or stabilizer of a protease in the context of a washing or cleaning agent recipe;
washing or cleaning method in which a protease which is inhibited and/or stabilized with a compound described above is put into effect;
the use of washing or cleaning agent as contemplated herein for washing and/or cleaning of textiles and/or hard surfaces; as well as
the use of a protease and a compound described above to produce a washing or cleaning agent.

Washing or cleaning agents as contemplated herein, which are present in a predominantly solid form in one embodiment and, in another embodiment, in a predominantly liquid, pasty or gel form, the enzyme, i.e. the protease, is contained in an amount of from about 0.05 to about 5 wt. %, preferably from about 0.05 to about 2 wt. %, and the enzyme stabilizer is contained in an amount of from about 0.05 to about 15 wt. %, preferably from about 0.05 to about 5 wt. % relative to the total weight of the washing or cleaning agent.

In various embodiments, the enzyme and the enzyme stabilizer can be provided pre-formulated in an enzyme composition, wherein the enzyme is contained in the enzyme composition in an amount of from about 0.05 to about 15 wt. %, preferably from about 0.05 to about 5 wt. % and the enzyme stabilizer is contained in an amount of from about 0.05 to about 35 wt. %, preferably from about 0.05 to about 10 wt. % relative to the total weight in the enzyme composition. This enzyme composition, which is also a component of the present disclosure, can be used washing or cleaning agents as contemplated herein in amounts which achieve the final concentrations specified above in the washing or cleaning agent.

In addition to the enzyme stabilizer in accordance with the general formula specified above, an agent as contemplated herein can contain at least one additional stabilizer, particularly a polyol, such as glycerin or 1,2-ethylene glycol and/or an antioxidant.

The protease stabilized and/or reversibly inhibited as contemplated herein is preferably a serin protease, particularly a subtilase, with particular preference being given to a subtilisin. The subtilisin can be a wild-type enzyme or a subtilisin variant, wherein the wild-type enzyme and/or the output enzyme of the variant is preferably selected from one of the following:
the alkaline protease of bacillus amyloliquefaciens (BPN′),
the alkaline protease of bacillus licheniformis (subtilisin Carlsberg),
the alkaline protease PB92,
subtilisin 147 and/or 309 (savinase)
the alkaline protease of bacillus lentus, preferably bacillus lentus (DSM 5483),
the alkaline protease of bacillus alcalophilus (DSM 11233),
the alkaline protease of bacillus gibsonii (DSM 14391) or an at least about 70% identical alkaline protease for this purpose,
the alkaine protease of bacillus sp. (DSM 14390) or an at least about 98.5% identical alkaline protease for this purpose, and
the alkaine protease of bacillus sp. (DSM 14392) or an at least about 98.1% identical alkaline protease for this purpose.

Agents as contemplated herein can contain, in addition to the protease, one or multiple additional enzymes, particularly from the following group: one or multiple additional proteases, amylases, hemicellulases, lipases and oxidoreductases.

The amylase(s) is(are) preferably a α-amylase. The hemicellulase is preferably a β-glucanase, a pectinase, a pullulanase and/or a mannanase. The cellulase is preferably a cellulase mixture or a single-component cellulase, preferably and/or predominantly an endoglucanase and/or a cellobiohydrolase. The oxidoreductase is preferably an oxidase, particularly a cholin oxidase or a perhydrolase.

The agents described here comprise all feasible types of washing or cleaning agent, both concentrates and undiluted agents to be applied, for use on a commercial scale, in the washing machine or for hand washing or cleaning. For example, this includes washing agents for textiles, carpets or natural fibers for which the designation washing agent is used. This also includes, for example, dishwashing detergent for dishwashing machine or manual dishwashing detergent or cleaners for hard surfaces, such as metal, glass, porcelain, ceramic, tiling, stone, painted surfaces, plastics, wood or leather for which the designation cleaning agent is used, i.e. in addition to manual and machine dishwashing detergents, for example, scouring agents, glass cleaner, WC fragrance rising aids, etc. The washing and cleaning agents in the context of the present disclosure also include washing aids which are added to the actual washing agent in the manual or machine textile washing in order to achieve an enhanced effect. Furthermore, washing and cleaning agents in the context of the present disclosure also include textile pre-treatment and post-treatment agents, i.e. such agents with which the article to be washed comes into contact before the actual washing, for example, to dissolve stubborn soiling, as well as such agents which lend additional desirable properties, such as a pleasant feel, crease resistance or low static charge in a subsequent step to the actual textile washing. The last-mentioned agents include fabric softeners, among other things.

Embodiments of the present disclosure comprise all solid, powdery, liquid, gel-like or pasty dosage forms of agents described here, which can optionally comprise of multiple phases and be provided in compressed or non-compressed form. The agent can be a pourable powder, in particular, with a bulk weight of from about 300 g/l to about 1200 g/1, particularly from about 500 g/l to about 900 g/l or from about 600 g/l to about 850 g/l. The solid dosage forms of the agent also include extrudates, granulates, tablets and pouches. Alternatively, the agent can also be liquid, gel-like or pasty, i.e. in the form of a non-hydrous liquid washing or dishwashing detergent or a non-hydrous paste or in the form of a hydrous liquid washing or dishwashing detergent or a hydrous paste. The agent can also be provided as a single-component system. Such agents comprise of one phase. Alternatively, an agent can comprise of multiple phases. One such agent is thus divided into multiple components.

The washing or cleaning agents describe here, which can be provided as a powdery solid, in post-compressed particle form and as homogeneous solutions or suspensions, can also include all known normal ingredients in such agents, wherein at least one additional ingredient is preferably included in the agent. The agents described here can contain, in particular, surfactants, builders, bleaching agents or bleach activators. Moreover, they can contain water-miscible organic solvents, sequestering agents, electrolytes, pH regulators and/or additional auxiliary ingredients, such as optical lighteners, graying inhibitors, foam regulators and colorants and fragrances, as well as combinations thereof.

Beneficial ingredients of agents described here are disclosed in the international patent application WO2009/121725, starting on page 5, last paragraph and ending on page 13 after the second paragraph. Express reference is made to this disclosure and the content of the disclosure is taken into account into the present patent application.

An additional subject of the present disclosure is a method for cleaning of textiles or hard surfaces, exemplified in that an agent describe here is used in at least one method step.

This includes manual and machine methods, where preference is given to machine methods. Methods for cleaning textiles are generally exemplified in that different cleaning-active substances are applied on the object to be cleaned in multiple method steps and washed off after an exposure time or that the object to be cleaned is treated with a washing agent or a solution or dilution of said agent in another manner. The same applies for methods for cleaning of all materials other than textiles, particularly hard surfaces. All feasible washing or cleaning methods can be enhanced in at least one of the method steps with the use of a washing or cleaning agent described here and then represent embodiments of the present disclosure.

A further subject of the present disclosure is the use of an agent describe here for cleaning or washing of textiles or cleaning of hard surfaces.

Another subject of the present disclosure is the use of the compounds described here for stabilization of an enzyme in a protease-containing washing or cleaning agent.

All circumstances, subject matter and embodiments which are described for agents described here are also applicable to the aforementioned methods and uses. Therefore, express reference is hereby made to the disclosure in the relevant place with the notice that said disclosure also applies for the methods and uses described above.

### EXAMPLES

### Example 1

The storage stability of protease-containing washing and cleaning agents in the presence of candidate compounds was studied for use as enzyme stabilizers. The alkaline protease of bacillus lentus (DSM 5483) was used with the substitution R99E as a protease. For this purpose, the candidate compounds (See Table 2) were formulated in parallel reaction batches in the presence of 1,2-propane diol at 1% (w/w) in a washing or cleaning agent formulation (see Table 1). Then the protease 1% (w/w) was added to the formulation and the formulation was stored for 20 h, 140 h and 234 h at 30° C. Only protease and the washing or cleaning agent formulation (and 1% w/w 1,2-propane diol) were contained in the control batch.

Then the proteolytic activity of the 1% protease were determined from the described reaction batches. For this purpose, the release of chromophor para-nitroanilin was determined from the substrate succinyl alanine-alanine-proline-phenylalanine-para-nitroanilide (AAPFpNA; Bachem L-1400). The release of the pNA causes an increase in the extinction at 410 nm, the time profile of which is a measure of the enzymatic activity. The measurement took place at a temperature of 25° C., with pH 8.6 and a wavelength of 410 nm. The measuring time was 5 min with a measuring interval of 20 to 60 seconds.

The initial values for the proteolytic activity of the relevant agent are compared with the values determined after the storage for the evaluation. The higher the remaining activity is after the storage, the better the achieved protease is while the storage is inactivated and the better the relevant compound is suitable as a stabilizer as contemplated herein. The stabilizing effect of the tested compound, therefore, is measured as a relative percentage increase of the protease residual activity.

TABLE 1
Formulation of the activity test

| Component | Quantity (wt. %) |
|---|---|
| Demineralized water | Remaining |
| Citric acid | 1.42623 |
| Defoamer (10%) | 0.008 |
| Fatty alcohol ether sulfate | 5.6 |
| (70%) | |
| Fatty alcohol ether | 4.4 |
| Alkyl benzol sulfonic acid | 4.4 |
| (96%) | |
| C₁₂₋₁₈ fatty acid | 2.4 |
| NaOH (50%) | 0.95 |
| Glycerin (99.5%) | 2 |
| Phosphate (DTPMP-Na₇H₃) | 0.2 |
| (32%) | |
| Preservative | 0.10 |
| Ethanol (93%) | 1 |

The pH value of the formulation was adjusted to 8.4 by the NaOH. The formulation was clear and colorless.

The following were tested as candidate compounds: 3-methyl-1,2-benzothiazol-1,1-dioxide and 3-butyl-1,2-benzothiazol-1,1-dioxide.

TABLE 2
measured protease residual activity of the candidate compounds

| | Relative residual activity after | | | |
|---|---|---|---|---|
| | incubation with KV in % | | | |
| Candidate compound (KV) | 0 h | 20 h | 140 h | 234 h |
| None - only protease | 100 | 100.8 | 67.9 | 59.9 |
| 3-methyl-1,2-benzoisothiazol-1,1- | 100 | 98.2 | 72.7 | 67.4 |
| dioxide | | | | |

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein. It being understood that various changes may be made in the function and arrangement of elements described in an exemplary embodiment without departing from the scope of the various embodiments as set forth in the appended claims.

1. Washing or cleaning agents comprising at least one protease and at least one enzyme stabilizer, wherein the at least one enzyme stabilizer is selected from the group of compounds of the general structural formula (I) 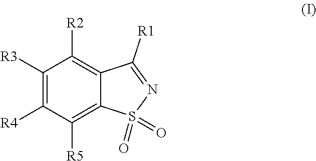
wherein R1 denotes a C₁-C₆ alkyl group, a C₂-C₆ alkenyl group, a C₂-C₆ hydroxy alkyl group, a C₁-C₆ alkyl-oxy-C₁-C₆ alkyl group, a carboxy-C₁-C₆ alkyl group, an aryl-C₁-C₆ alkyl group, a heteroaryl-C₁-C₆ alkyl group, an aryl group, or a heteroaryl group, and
R2, R3, R4, and R5, each independently of each other, denote hydrogen, a C₁-C₆ alkyl group, a halogen atom, or a C₁-C₆ acyl group.

2. Washing or cleaning agent according to claim 1, wherein R1 of the general structural formula (I) denotes a C₁-C₆ alkyl group, a C₂-C₆ alkenyl group, or a C₂-C₆ hydroxy alkyl group.

3. Washing or cleaning agents according to claim 1, wherein R2, R3, R4 and R5 of the general structural formula (I) denote hydrogen.

4. Washing or cleaning agents according to claim 1, wherein the compound according to formula (I) is 3-methyl-benzisothiazol-1,1-dioxide, 3-ethyl-benzisothiazol-1,1-dioxide, 3-(1-propyl)-benzisothiazol-1,1-dioxide, 3-isopropyl-benzisothiazol-1,1-dioxide, 3-(1-butyl)-benzisothiazol-1,1-dioxide, 3-(2-butyl)-benzisothiazol-1,1-dioxide, or 3-(tert-butyl)-1,2-benzisothiazol-1,1-dioxide.

5. Washing or cleaning agent according to claim 1, wherein the at least one protease is comprised in an amount of from about 0.05 to about 5 wt. % relative to the total weight of the washing or cleaning agent.

6. Washing or cleaning agent according to claim 1, wherein the washing or cleaning agent is utilized for washing of textiles or cleaning of solid surfaces.

7. Method for cleaning textiles or hard surfaces wherein a washing or cleaning agent according to claim 1 is applied in at least one method step.

8. (canceled)

9. Washing or cleaning agent according to claim 2, wherein R1 of the general structural formula (I) denotes a C₁-C₆ alkyl group.

10. Washing or cleaning agent according to claim 9, wherein R1 of the general structural formula (I) denotes a methyl, ethyl, n-propyl, isopropyl, n-butyl, 2-butyl, or tert-butyl.

11. Washing or cleaning agent according to claim 10, wherein R1 of the general structural formula (I) denotes methyl.

12. Washing or cleaning agent according to claim 4, wherein the compound according to formula (I) is 3-methyl-benzisothiazol-1,1-dioxide.

13. Washing or cleaning agent according to claim 5, wherein the at least one protease is comprised in an amount of from about 0.05 to about 2 wt. % relative to the total weight of the washing or cleaning agent.

14. Washing or cleaning agent according to claim 1, wherein the at least one enzyme stabilizer is comprised in an amount of from about 0.05 to about 15 wt. % relative to the total weight of the washing or cleaning agent.

15. Washing or cleaning agent according to claim 14, wherein the at least one enzyme stabilizer is comprised in an amount of from about 0.05 to about 5 wt. % relative to the total weight of the washing or cleaning agent.

16. Washing or cleaning agents-, comprising:
at least one protease comprising a subtilisin protease; and
at least one enzyme stabilizer comprising 3-methyl-benzisothiazol-1,1-dioxide;
wherein the at least one protease is comprised in an amount of from about 0.05 to about 2 wt. % relative to the total weight of the washing or cleaning agent; and
wherein the at least one enzyme stabilizer is comprised in an amount of from about 0.05 to about 5 wt. % relative to the total weight of the washing or cleaning agent.

17. Washing or cleaning agent according to claim 16, wherein the subtilisin protease is an alkaline protease of bacillus lentus (DSM 5483) with the amino acid substitution R99E.
